(19) United States
(12) Patent Application Publication
(10) Pub. No.: US 2007/0168591 A1
(43) Pub. Date: Jul. 19, 2007

(54) System and method for validating codec software

(75) Inventor: Teck-Kuen Chua, Scottsdale, AZ (US)

Correspondence Address: INTER-TEL, INC., 7300 WEST BOSTON STREET, CHANDLER, AZ, 85226, US

(73) Assignee: INTER-TEL, INC.

(21) Appl. No.: 11/299,148

(22) Filed: Dec. 8, 2005

(51) Int. Cl. G06F 13/38

(52) U.S. Cl. 710/72

(57) ABSTRACT

A system for validating codec software includes sending to a validation server duplicates of the real-time endpoint encoder and decoder input/output datas. A comparator of the validation server compares the encoder output data to a pre-tested reference code and the decoder output data to a pre-tested reference code. The process continues for as long as the endpoints are in the live audio session or until the validation server terminates collection of data. In one embodiment, the comparator may send an error message to an alert device if a mismatch between the datas is encountered. The system may further include a speech quality evaluator for determining a real-time QoS of the networked speech. The evaluator collects the encoder output data of a first endpoint and the same data after traveling through the data network and presented as the decoder input data of a second endpoint to determine the QoS.

### FIELD OF INVENTION

The present invention relates generally to systems and methods for validating codec software and particularly, for validating the operational performance of codec software used in digital communications networks.

### BACKGROUND OF THE INVENTION

Codecs or audio coders are widely used in the telephony industry to prepare voice signals for digital transmission. In some communication systems, the codec is in a PBX or other switching system, and shared by many endpoints. In other systems, the codec is actually in the endpoint. Thus, the endpoint itself sends out a digital signal and can, as a result, be more easily designed to accept a digital signal.

Validating software, such as the software used in codecs, is perhaps more daunting than any other task that the software developer faces. Troubleshooting and isolating software errors in complex real-time embedded software is always challenging, and can be even more difficult when the software involves many intricate DSP algorithms, such as with the audio coder. The difficulty in validating software increases disproportionately as the software grows in terms of size and complexity. Software engineers frequently need to perform complicated software testing tasks with limited or inadequate validation tools.

It is believed that software validation may account for over half of the total cost of software development. There is a market acceptance cost as well as the direct monetary cost of resources needed to solve the complex software validation problem. A delayed time to market can cause the business to lose market share as well as timely revenue. On the other hand, releasing an untested or flawed product into the market can cost the business even more in the future. The purchase of new validation and testing tools as well as the engineering resources required to test and validate the software represent a considerable labor cost.

Over the past decade, voice-over-internet protocol (VoIP) or packet-based networking techniques have become an increasingly popular alternative to the standard ISDN for transport of voice traffic. However, the introduction of VoIP also introduces many challenges in testing and validating the VoIP software and evaluating the VoIP network quality of service (QoS). The VoIP system includes audio codecs at both the receiving and transmitting ends. The audio-coder algorithm encodes digital audio data into a compressed form to minimize the bandwidth needed for transmitting the audio across a data network. When the encoded audio reaches its destination, the receiving unit decodes the compressed audio data into a format that can be played back. Since audio-coder algorithms encode and decode audio data, the correctness of an audio-coder implementation directly affects the audio quality of a VoIP system.

The advanced audio-codec algorithms used in the VoIP applications can be extremely complex, thus increasing the challenge of validating the codec implementation. Various coder algorithms are available and each one uses its own technique and has its own level of code complexity. For example, the ITU-T (International Telecommunication Union Standardization Sector) standard G.711 Pulse Code Modulation audio coder has relatively low code complexity. On the other hand, the ITU-T standard G.729 Conjugate Structure Algebraic Code Excited Linear Prediction (CS-ACELP) audio-coder algorithm is extremely complex. Consequently, there are more than ten thousand assembly instructions where the software problems can hide. Isolating the software errors in such a large scale real-time assembly application is a significant challenge. Furthermore, G.729 is a history-dependent audio coder, so past audio data leading to the poor audio quality plays a significant role in the problem and further increases the task of finding and correcting the software errors.

The ITU-T standards, such as G.723.1, G.728, and G.729, publish a prescribed set of inputs and outputs called test vectors. The test vectors may be used to develop assembly code for the desired DSP platform that produces the bit-exact required result from the input test data. The developer then prepares the audio coder for alpha testing and then field testing. Using this process, the audio quality is good most of the time. However, even with the utmost care during development, acute listeners may hear a sporadic loud pop, static noise, loud squeals, or badly distorted speech. The problem can happen a few minutes into a communication, after a long conversation, or never at all. The occurrences of poor audio quality are so intermittent that it is not possible to reliably reproduce the errors at will. The existing standard test vectors fail to detect a number of errors, some subtle and obscure, but others blatant and catastrophic. Specifically, merely matching the standard's particular test vectors to validate software operation is an inadequate process alone for certifying the correctness of an audio coder implementation.

Furthermore, current tools certainly do not facilitate capturing and correcting errors in a real-time codec. The software is processing at 8,000 audio samples every second. The G.729 encoder and decoder algorithms are encoding and decoding audio data at intervals of ten milliseconds. When the user hears distortion and perceives the presence of an error, the time for stopping and tracking the error is already long past. At this processing rate, we cannot rely on human intervention to observe the problem and stop the application when an error occurs.

Since it is not possible to rely solely on the test vectors published in the ITU-T standard, the reference C-code published in the standard is another alternative for certifying the correctness of the G.729 implementation. As noted previously, the G.729 audio coder is implemented in assembly language. This is because the compiled C-code requires too much memory from the target platform. Since the G.729 algorithm is implemented in assembly code that is unique to the target processor, the assembly program cannot run on a larger platform with a different and higher-end processor. The only remaining choice is to run the G.729 assembly code on the target platform and to run the ITU-T reference C-code on a different and more powerful platform. For every new sequence of audio input data, the system must use the reference C-code to generate the corresponding correct output. The audio input data must then be manually downloaded to the target platform. Next, the G.729 assembly code is run to generate a set of output values and these outputs are compared to the output that the reference C-code generated. These steps are then repeated for each new set of audio input data that is needed for the test. As is apparent from the numerous operational steps, running the tests on two disconnected and independent platforms is time consuming and terribly inefficient. Due to the significant complexity of the G.729 audio coder algorithm, there are endless possible sets of input test data. It is unlikely that current test methods will be able to specify complete sets of input test data to test the algorithm thoroughly.

Since G.729 is a history dependent audio coder, the length of each set of input audio test data is an important factor. If an audio test input induces an error after two minutes of audio then simply applying the last part of that input would not normally produce the same error. Additionally, an error in the output of the algorithm may not be instantly audible. An inaudible minor error can lead to a subsequent severe error that seriously impairs the audio quality. Therefore, capturing the error before it becomes noticeable is critical in the debugging process. When the user hears the error, the audio data values have already gone through both G.729 encoding and G.729 decoding. The developer cannot readily determine whether the error is in the encoder algorithm, whether it is in the decoder algorithm, or whether it is a result of some obscure interaction between the encoder and the decoder. Even if the developer can identify the flawed algorithm, the error could still be the result of any one of thousands of assembly-language instructions. In addition, the developer faces the frustrating challenge of reproducing the exact software error since the behavior is erratic in nature.

Another difficulty in producing sets of input test data is deciding what audio sequence to use. There are many combinations of audio characteristics in a set of input audio data which all affect the outcome of a test. These characteristics include pitch, amplitude, length, rhythm, zones of silence, and so on. It must be determined what the exact combination of the audio characteristics were in the network in order to produce the same error.

Additionally, the inherent problems in packet-based networks, such as packet loss and delay jitter, can greatly impair the QoS. When the receiving endpoint receives the encoded audio packets from the transmitter, the audio packets have traveled through the packet-switched network and been affected by the above-mentioned problems that degrade the audio quality. As the receiving endpoint decodes the encoded audio and plays the decoded output to the user, the user hears the degraded-quality audio.

Accordingly, a system and method for improved validating of codec software is needed and, especially for the advanced audio-codec algorithms used in the VoIP applications. A software validation system is needed to yield a shorter product development time, quicker analysis of errors, and fewer production issues.

Consequently, a new validation system is desired that is effective in the software-validation process as well as efficient in the debugging process. Additionally, it would be beneficial to implement a real-time QoS valuation system to evaluate the network effect on the communication.

### BRIEF DESCRIPTION OF THE DRAWINGS

These and other features, aspects, and advantages of the present invention may be best understood by reference to the following description taken in conjunction with the accompanying drawings, wherein like reference numerals indicate similar elements:

FIG. 1 illustrates an exemplary system for validating codec software in accordance with the various embodiments;

FIG. 2 illustrates, in block format, an exemplary implementation of the validation server for an instance of a validation session;

FIG. 3 illustrates, in block format, an exemplary implementation of the target endpoint for an instance of a validation session;

FIG. 4 illustrates, in block format, an exemplary implementation of the validation server for a dual session validation and speech quality evaluation; and

FIGS. 5A-5D illustrate exemplary packet structures in accordance with the various embodiments of a validation system.

### DETAILED DESCRIPTION

The present invention provides improved system and methods for validating codec software used in digital communications networks. The system includes a remote validation server in communication with the target system to operate a pre-tested “accepted-as-standard” version of the encoder-decoder software as a benchmark for the target system. Each endpoint of a target system sends the validation server both encoder and decoder input/output data. The data is sent to the server simultaneously with the transmit of similar audio packets to the other endpoint during a real-time live communication. Because the validation server may be located anywhere on a network, it may be used to evaluate system performance in real time and under actual operating conditions.

Because the system is already processing packets obtained over the network from an operating system, it is possible to perform a real-time QoS (quality of service) evaluation on the speech signals. Since the system is performing live testing during an active telephone session, the decoder at the receiver is using speech input that has gone through the network and experienced network's affect on the quality of the speech, e.g., packet loss, delay jitter, etc. When the receiver sends the input test data of its decoder to the validation server, in addition to validating the decoder algorithm, the server can easily run the speech data through a speech quality evaluation algorithm to obtain real-time readings of the speech quality.

A system and method for validating codec software in accordance with the embodiments meets the demanding operational challenges facing developers and resolves the difficult software-validation and testing problem. The system can validate the correctness of an implementation of an audio coder in real time during a live telephone conversation. The methods can be used in the software development phase and can be applied to test the final product. The approach reduces the time for software validation and debugging from weeks or months down to minutes or hours.

For convenience, the following description is with respect to validating complex VoIP audio-coder algorithms. It should be realized that the systems and methods are suitable for various other algorithms and software systems. Additionally, the following description is conveniently described with respect to VoIP technology, but various other technologies are equally as acceptable, such as using a PCI interface if the embedded hardware is a PCI board.

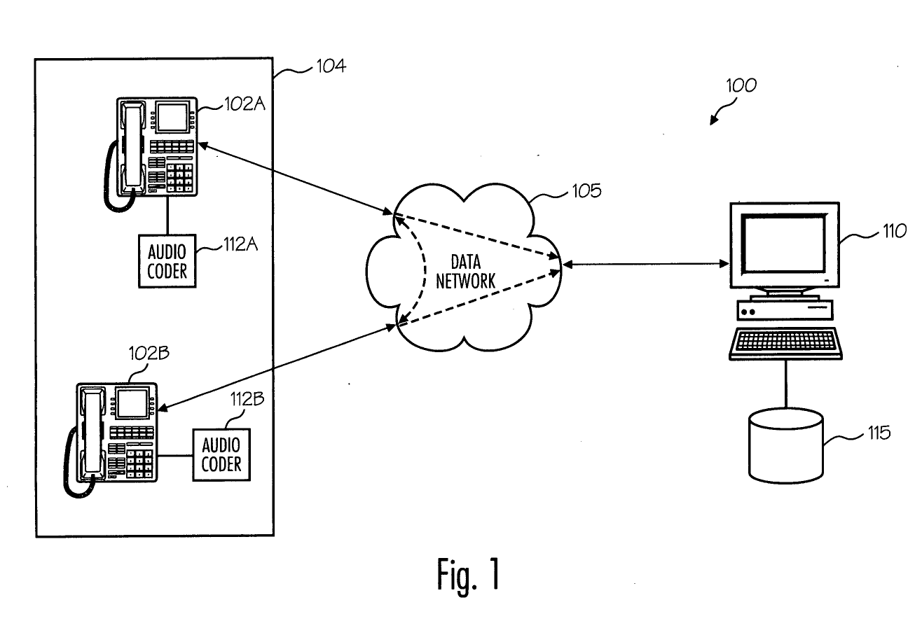

FIG. 1 illustrates an exemplary system 100 for validating VoIP codec software in accordance with the various embodiments. In general, system 100 includes a target system 104, a data network 105, and a validation server 110.

Used herein, “target system” refers to the endpoint(s) and the data networks coupling the endpoint(s) under test. In accordance with the embodiments, the target system under test is engaged in live communication. Target system 104 includes one or more communication endpoints 102 coupled to data network 105. Endpoints 102 may include a variety of suitable communication devices which are capable of digital communications, e.g., IP keysets, PDAs, mobile telephones, pagers, personal computing devices, and so on. Endpoints 102 preferably include an audio coder 112 for encoding and decoding the communication data. Typically, the audio coder or codec is embedded in the endpoint if the endpoint is capable of digital transmissions on its own. However, it is not essential that the codec be integrated in the endpoint, only coupled to the target system. As illustrated, target system 104 includes two endpoints, 102A and 102B, however it should be realized that more or less endpoints may comprise the target system.

Data network 105 can be a private local area network (LAN) or a public network such as the Internet. In some cases, it may be preferable to use a reliable LAN to avoid or reduce lost packets of test data or audio data. If the network is unreliable and is losing packets, the user can implement certain well established loss-recovery techniques to ensure that the system receives the test data in the network. The loss-recovery technique does not necessarily have to be a tight latency-bound technique, but it should be able to recover all of the lost data. Data network 105 may include multiple networks coupled together. For example, it may be preferred in some instances to have a separate dedicated high-speed connection, e.g., USB, firewire, parallel bus, between target system 104 and validation server 110 to make sure that every packet is available for an accurate verification.

Assuming for this example, the target system 104, comprising endpoints 102A and 102B, is currently engaged in a live VoIP telephone conversation. Packets of digitized data are sent from endpoint 102A to endpoint 102B where audio coder 112B decodes the data for play back. In a similar manner, endpoint 102B may transmit packets of data to endpoint 102A for decoding and play back. The transmission of packets between the endpoints is represented by dashed lines in FIG. 1. During a validation session, the target endpoints 102A and 102B send the input and output data of its audio encoder plus the input and output data of its audio decoder to validation server 110 (represented by dashed lines in the Figure to validation server 110). Note that the target endpoints send both the input and output data of both its encoder and decoder to validation server 110. Since the IP endpoints already have established connections within the data network 105, a connection to validation server 110 and delivery of the input and output data over data network 105 to validation server 110 is not a difficult task.

Validation server 110 includes a validation application for performing the software verification. Validation server 110 couples to data network 105 and the endpoints or platforms associated with the audio coders to be analyzed. Typically, validation server 110 has high processing capabilities and includes a database storage 115. Although shown as a single database in the figure, it should be appreciated that database storage 115 may comprise several storage facilities linked together. Validation server 110 stores in database 115 the incoming input and output test data for each validation session. Each endpoint periodically sends its current CPU context and relevant memory values to validation server 110 and this state information is also saved in database 115. Additional details of the validation server and its application will be discussed below.

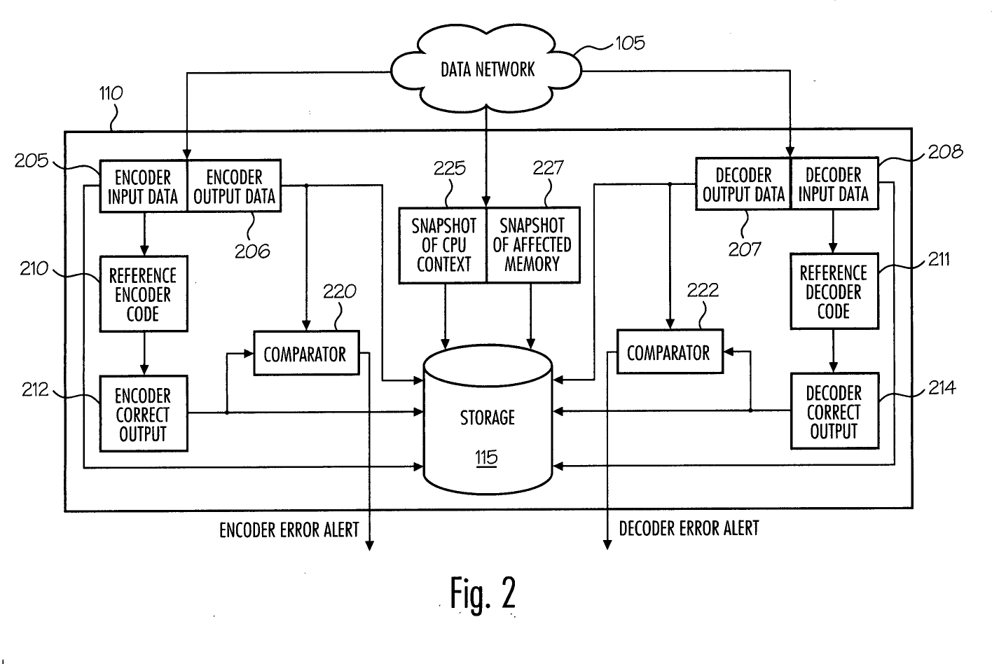

FIG. 2 illustrates, in block format, an exemplary implementation and various components of validation server 110 for an instance of a validation session.

Validation server 110 is capable of conducting and managing multiple validation sessions simultaneously. The validations of the encoder implementation and the decoder implementation are independent of each other. Therefore, validation server 110 is able to validate the correctness of the encoder without any active decoder validation session, and vice versa.

The ITU-T standards published test vectors fall short of providing a complete validation for software. However, the test vectors in general are not inherently flawed. In fact, well-crafted test vectors can still be useful in detecting errors. But because most of the endpoint devices in telecommunication systems use small embedded processors with very limited memory and CPU bandwidth, the C code cannot be used directly by the endpoints. For example, when implemented on an ADSP-218x DSP, the compiled G.729 C code requires about four times as much memory as the hardware has available. So storing the ITU-T reference C code at the endpoints is not feasible, but it is possible to store the code in database 115 of validation server 110.

With continued reference to FIG. 2, the target endpoint sends its encoder input/output data 205/206 and its decoder input/output data 207/208 to validation server 110. The validation application preferably uses a reference encoder code 210, e.g., ITU-T G.729 C code, and a reference decoder code 211, e.g., ITU-T G729 C code, to generate an encoder correct output 212 and a decoder correct output 214. Then the validation application compares 220 the correct encoder output data 212 against the encoder output data 206 that the endpoint implementation provided. Similarly, the correct decoder output data 214 is compared 222 to the decoder output data 207 received from the endpoint.

Periodically, the target endpoint takes a snapshot of its state information and sends this data to validation server 110 (illustrated as the dashed lines in FIG. 1 to validation server 110). For example, the endpoint may send its CPU context 225 and significant memory values 227. This state information 225/227 is stored in storage 115.

The validation application continues to verify the data as long as the application does not find any errors. If comparator 220 or 222 encounters a mismatch between the correct output data and the test data, validation server 110 may terminate the validation session. In one embodiment, validation server 110 sends an error alert to a receiving alert device such as a computer, pager, cell phone, IP phone, personal digital assistant (PDA), etc. The alert message may be transmitted via various communication media and methods, e.g., instant messaging, email, pager, fax, PDA, or telephone call using VoIP, public switched telephone network (PSTN), cell-phone technology, etc.

In one embodiment, when the validating system discovers an error, the developer can retrieve the endpoint's previous state information from storage 115 and download the information to a simulator or through an in-circuit emulator to the target platform. Then the developer can exercise the erroneous audio-coder implementation using the stored input audio data that follows the restored state. The state information allows the engineer to run the test from a point in the audio stream shortly before the error. This saves a substantial amount of debugging time by pinpointing where the error occurred. The stored erroneous output data and correct output data are useful reference data for the developer when debugging and correcting the error.

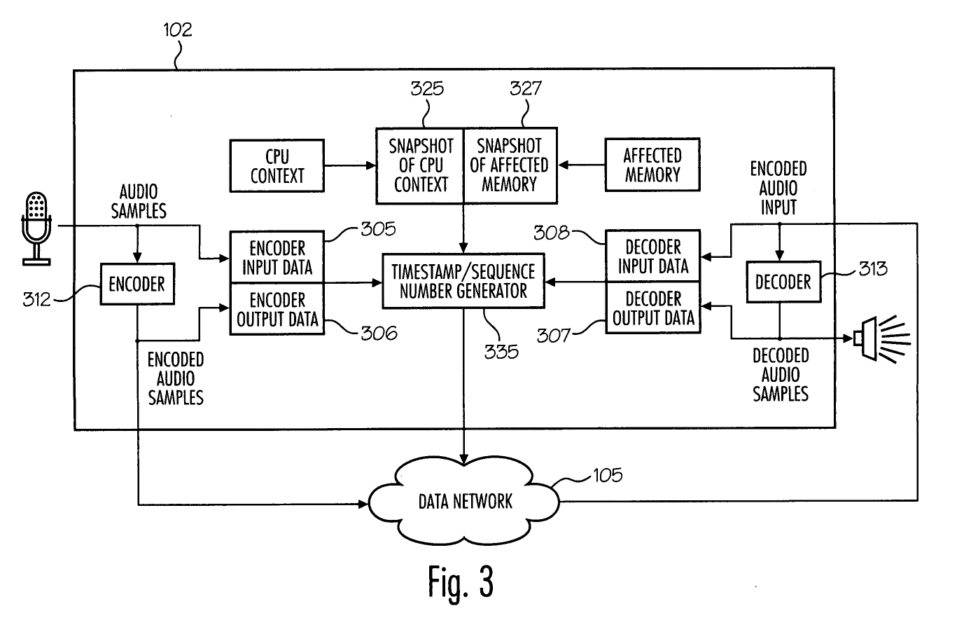

FIG. 3 illustrates, in block format, an exemplary implementation and various components of target endpoint 102 for an instance of a validation session. Because many of the algorithms are history-dependent, the validation application should know when a new validation session is to begin. Endpoint 102 marks each set of input/output test data 305/306 and 307/308, as well as the state information 325/327 with a time stamp or sequence number 335 to identify the start of and sequence of the data and information. Validation server 110 stores the time stamp or sequence number along with received test data in storage 115.

As previously mentioned, each endpoint 102 preferably includes an encoder 312 and a decoder 313. The encoder/decoder pair may be implemented as single or multiple units. Encoder 312 receives the analog audio signals, for example, from a microphone coupled to the endpoint. The audio sample is also provided as encoder input data 305 as test data for validation. Encoder 312 receives the audio sample in digital format, for example from an A/D converter, and prepares the digital sample for transmission across data network 105 to the receiving endpoint. The preparation includes encoding, compressing the digital audio samples into a more compact format. Additionally, the encoded digitized audio sample is provided as encoder output data 306 as test data for validation. In a similar manner, decoder 313 receives an encoded audio sample from the other endpoint and decodes the data in preparation for play back. The received encoded audio sample is provided as decoder input data 308 as test data for validation. After the received audio sample is decoded, the decoded audio sample is provided as decoder output data 307 as test data for validation.

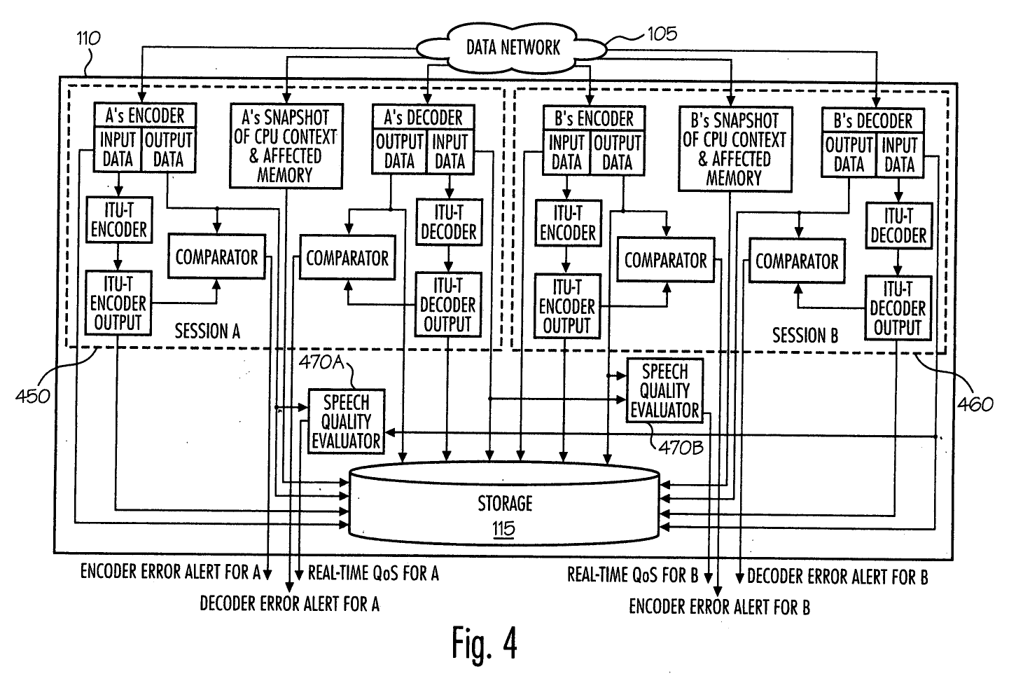

FIG. 4 illustrates, in block format, an exemplary implementation and various components of validation server 110 for an instance of a validation session. In particular, FIG. 4 sets forth an exemplary implementation of a dual session validation for target endpoints A and B and includes a speech quality evaluation feature. As previously mentioned, a validation system in accordance with the various embodiments is capable of managing multiple validation sessions simultaneously, e.g. endpoint 102A session 450 and endpoint 102B session 460. Validation server 110 validates the input/output data for each session 450, 460 as just described in the single session of FIG. 2.

In addition to validating the digital audio codec algorithm, a validation system in accordance with the embodiments includes a speech quality evaluator 470 that provides a real-time audio-quality valuation for a VoIP session. Because the validation system is able to perform live testing, during an active session the decoder at the receiver endpoint is using input that has gone through the data network. The quality of the received data (e.g., speech) may be affected by various network factors that contribute to the QoS, e.g., packet loss, delay jitter, etc. As the target endpoints 102 communicate in a VoIP session, speech quality evaluator 470 analyzes the QoS of the audio heard by the endpoint users. Speech quality evaluator 470 analyzes the encoder output stream from endpoint A to the decoder input data at endpoint B, and vice versa. To accomplish this, validation server 110 receives a copy of the original, undistorted audio stream from the endpoint as the input reference, as well as a copy of the audio stream after being transmitted across the network.

The output of speech quality evaluator 470 may be a well-known audio quality rating, such as the Mean Opinion Score (MOS) or some other QoS rating. MOS is a commonly used test to assess the speech quality. In this test, listeners rate a coded phrase based on a fixed scale. The MOS rating ranges from 0 to 5 and a MOS of 4 or higher is considered toll quality, which means that the reconstructed speech is almost as clear as the original speech. The speech quality evaluator feature allows users, administrators, engineers, and others to monitor, in real-time, the network effects on the QoS of a VoIP session. The results of the speech quality evaluator help the designer to decide if a different network design or topology is needed, to revaluate the performance and confirm improvements, or to confirm that further adjustments are needed.

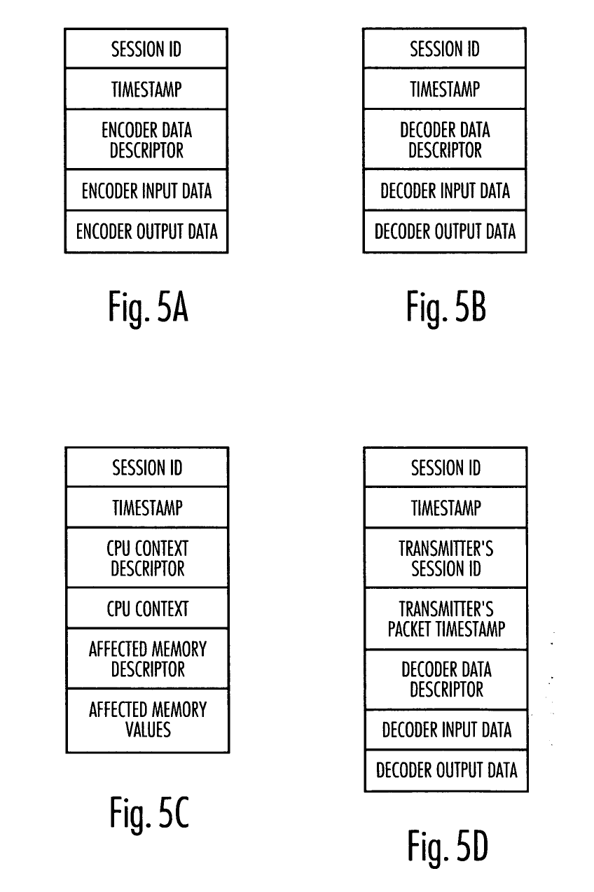

FIGS. 5A-5D illustrate exemplary packet structures for a validation system according to the various embodiments.

When endpoint 102 is ready to initiate a new validation session, endpoint 102 notifies validation server 110 regarding the start of the session. It is not uncommon for VoIP endpoints to support multiple voice coders in their implementations. Therefore, the target endpoint might use different types of voice coders from one session to another. The endpoint could also switch to use a different voice coder in the middle of an active session. Some voice coders, such as G.729 and GSM-AMR, support multiple compression ratios. The endpoint could change the output bit rate while using the same coder. For these reasons, validation server 110 is preferably able to support storage of a collection of reference programs. For these same reasons, when the target endpoint 102 is initiating a validation session with validation server 110, endpoint 102 reveals what type of coder it might and could use during the session. Consequently, each data packet received at validation server 110 may include a data descriptor that describes the content of the packet, including, but not limited to, the coder type, bit rate, input data length, output data length, first packet indicator.

In one embodiment, validation server 110 may verify that endpoint 102 is authorized, capable of, or permitted to undergo a validation session prior to approving the session. Validation server 110 approves the start of a validation session and provides a unique session ID to the endpoint(s) to identify the session. Validation server 110 may also reveal the type of coders that it supports. For identification, the endpoint attaches the session ID to each of the packets it sends to validation server 110.

FIG. 5C illustrates an exemplary packet structure that includes the endpoint state information such as CPU context and affect memory values of the endpoint. Typical information in the CPU context descriptor may include, but not limited to, register name, data width, layout of the CPU context section and so on. Affected memory descriptor may include, but not limited to, the memory locations, memory ranges, data width, and layout of the affected memory values section of the endpoint.

A speech quality evaluation feature may be implemented by changing the packet structure for the decoder/encoder test data that the endpoint sends to the validation server. FIG. 5D illustrates an exemplary decoder test packet and a similar example may be typical for the encoder test packet. The speech quality evaluation algorithm receives original reference speech as input in addition to the speech that is to be analyzed. In this case, the packet is provided with two new fields, “Transmitter's Session ID” and “Transmitter's Packet Timestamp”. “Transmitter's Session ID” is the session ID for the transmitter's encoder validation session. “Transmitter's Packet Timestamp” is the corresponding timestamp use in the encoder test data that the sender sends to the validation server. These two fields allow the server to find the correct session and segment of the transmitter's encoder data and use it as the reference speech in the analysis.

Presented herein are various systems, methods and techniques for evaluating VoIP code software, including the best mode. Having read this disclosure, one skilled in the industry may contemplate other similar techniques, modifications of structure, arrangements, proportions, elements, materials, and components for evaluating VoIP codec software, and particularly for evaluating the operational performance of the software in a digital communications network, that fall within the scope of the present invention. These and other changes or modifications are intended to be included within the scope of the present invention, as expressed in the following claims.

1. A system for validating codec software during a real-time audio session, the system comprising:
a target system comprising one or more endpoints engaged in a real-time audio session, each of the endpoints coupled to an audio coder having codec software running thereon and configured to receive an encoder input data and produce an encoder output data and to receive a decoder input data and produce a decoder output data, the encoder input data comprising a real-time digital audio sample and the decoder input data comprising a real-time digital encoded audio sample;
a data network routing a plurality of packetized data among the endpoints of the target system and among the target system and a validation server; and
the validation server comprising a database and a comparator, during the session the validation server configured to receive from the target system the encoder input data, the encoder output data, the decoder input data and the decoder output data, the comparator configured to receive the encoder and decoder output datas and compare the output datas to a stored pre-tested reference encoder data and a pre-tested reference decoder data, respectively, and the comparator configured to transmit an error message to an alert device indicating a mismatch between the reference datas and the output datas.

2. The system of claim 1, wherein the target system configured to periodically transmit a state information for storage at the validation server.

3. The system of claim 2, wherein the error message indicates the state information for the endpoint of the target system.

4. The system of claim 2, wherein the state information comprises current CPU context and affect memory of the endpoint.

5. The system of claim 1, wherein the validation server is configured to terminate comparing upon transmission of the error message.

6. The system of claim 1, wherein each endpoint of the target system includes a timestamp generator and the endpoint timestamps the data prior to sending the data to the validation server.

7. The system of claim 1, wherein the target system includes two endpoints and the validation server receives data from both the endpoints and the validation server compares the data for both endpoints simultaneously during the session.

8. The system of claim 1, wherein the validation server further comprises a speech quality evaluator and during the session the evaluator configured to receive the encoder output data of a first endpoint and the decoder input data of a second endpoint to evaluate the speech quality of the data.

9. The system of claim 8, wherein the speech quality evaluator is configured to determine a Mean Opinion Score of the data.

10. The system of claim 1, wherein the validation server comprises a plurality of pre-tested reference codes to support a plurality of audio coders.

11. A system for evaluating the QoS (quality of speech) of real-time audio data, the system comprising:
a target system comprising a first endpoint and a second endpoint engaged in a real-time audio session, each of the endpoints coupled to an audio coder configured to receive an encoder input data and produce an encoder output data and to receive a decoder input data and produce a decoder output data, the encoder input data comprising a real-time digital audio sample and the decoder input data comprising a real-time digital encoded audio sample;
a data network routing a plurality of packetized data among the endpoints of the target system and among the target system and a validation server; and
the validation server comprising a database and a speech quality evaluator and during the session the evaluator configured to receive a duplicate of the encoder output data of the first endpoint and the decoder input data of the second endpoint, wherein the decoder input data of the second endpoint is the encoder output data of the first endpoint after transmission across the data network, and the speech quality evaluator configured to evaluate the speech quality of the data and to transmit a real-time QoS rating for the first endpoint.

12. The system of claim 11, wherein the target system configured to periodically transmit a state information for storage at the validation server.

13. The system of claim 11, wherein the speech quality evaluator is configured to determine the Mean Opinion Score of the real-time audio data.

14. A method for validating codec software during a real-time audio session of a target system, the target system comprising a first endpoint and a second endpoint engaged in live audio communication, the method comprising:
receiving, at a remote validation server from the first endpoint, an encoder input data comprising a real-time digital audio sample of the first endpoint and an encoder output data comprising the digital audio sample encoded for digital transmission;
receiving, at-the validation server, a decoder input data comprising a real-time digital encoded digital sample of the second endpoint and the decoder output data comprising the digital sample of the second endpoint decoded by the first endpoint;
comparing the received encoder output data to a pre-tested reference encoder output;
comparing the received decoder output data to a pre-tested reference decoder output;
continuing the comparing for all received data; and
transmitting an error message to an alert device indicating a mismatch between the reference output and the output datas.

15. The method of claim 14 further comprising, receiving periodically, at the validation server, a state information from the first and second endpoints.

16. The method of claim 15, wherein the state information comprises current CPU context and affect memory of the endpoint.

17. The method of claim 14 further comprising, terminating the comparing upon transmission of the error message.

18. The method of claim 14 further comprising,
receiving, at the validation server, an encoder output data of the first endpoint;
receiving, at the validation server, a decoder input data of the second endpoint comprising the encoder output data of the first endpoint after transmission through a data network;
evaluating a speech quality of the received data; and
transmitting a real-time quality of speech rating for the first endpoint.

19. The method of claim 18 wherein the speech rating comprises a Mean Opinion Score of the data.

20. The method of claim 14 further comprising, storing a plurality of pre-tested reference encoder and decoder outputs.
